(19) United States
(12) Patent Application Publication
(10) Pub. No.: US 2014/0367373 A1
(43) Pub. Date: Dec. 18, 2014

(54) APPLIANCE FOR THAWING SNOW OR ICE

(71) Applicant: John C. Atherton, Beaverton, OR (US)

(72) Inventor: John C. Atherton, Beaverton, OR (US)

(21) Appl. No.: 13/917,459

(22) Filed: Jun. 13, 2013

(51) Int. Cl. H05B 3/42

(52) U.S. Cl. CPC H05B 3/42
USPC 219/439

(57) ABSTRACT

An appliance for thawing snow or ice, comprising a container defining an interior space, a rod-form element extending longitudinally into the interior space of the container and spaced from walls of the container about its entire circumference, whereby an external surface of the rod-form element is exposed to material in the interior space, wherein the rod-form element is hollow and defines a passage that is open at an exterior surface of the container, the rod-form element having an end within the interior space of the container and at which the passage is closed, and a heating tool including a heating element sized to fit closely within the passage defined by the rod-form element, whereby heat dissipated in the heating element is transferred through the rod-form element to the material in the interior space of the container.

### BACKGROUND OF THE INVENTION

The subject matter disclosed herein relates to an appliance for thawing snow or ice.

Dehydration and hypothermia are among the serious dangers faced by persons in wilderness conditions. In winter, the danger of hypothermia is even more serious due to the cold. Although snow or ice may be available as a source of water in winter, snow or ice should not be ingested to relieve dehydration because the need to supply energy to melt the snow or ice may increase the likelihood of succumbing to hypothermia.

### SUMMARY OF THE INVENTION

In accordance with the subject matter disclosed herein there is provided an appliance for thawing snow or ice, comprising a container defining an interior space, a rod-form element extending longitudinally into the interior space of the container and spaced from walls of the container about its entire circumference, whereby an external surface of the rod-form element is exposed to material in the interior space, wherein the rod-form element is hollow and defines a passage that is open at an exterior surface of the container, the rod-form element having an end within the interior space of the container and at which the passage is closed, and a heating tool including a heating element sized to fit closely within the passage defined by the rod-form element, whereby heat dissipated in the heating element is transferred through the rod-form element to the material in the interior space of the container.

In accordance with one aspect of the disclosed subject matter the rod-form element is made of metal.

In accordance with one aspect of the disclosed subject matter, the rod-form element is integrally formed with a plug fitted in an opening in a wall of the container.

### BRIEF DESCRIPTION OF THE DRAWINGS

For a better understanding of the invention, and to show how the same may be carried into effect, reference will now be made, by way of example, to the accompanying drawings, in which:

FIG. 1 is a side elevation of an appliance for thawing snow or ice,

FIG. 2 is an enlarged partial view of the appliance, showing the container in section,

FIG. 3 is an exploded perspective view of the container, and

FIG. 4 is a partial exploded view of the soldering tool.

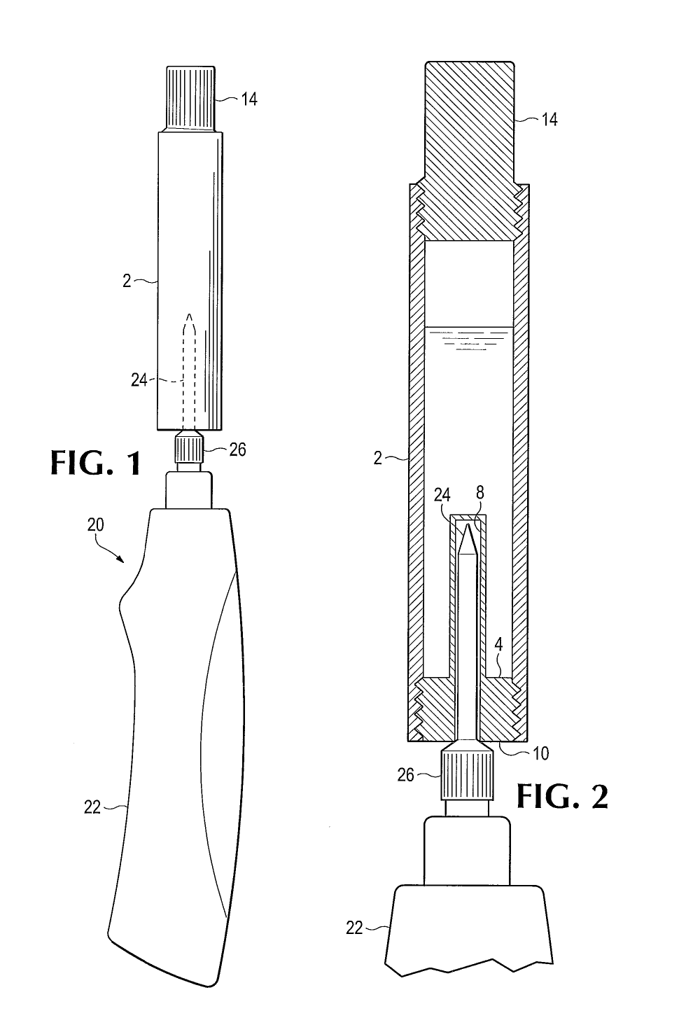

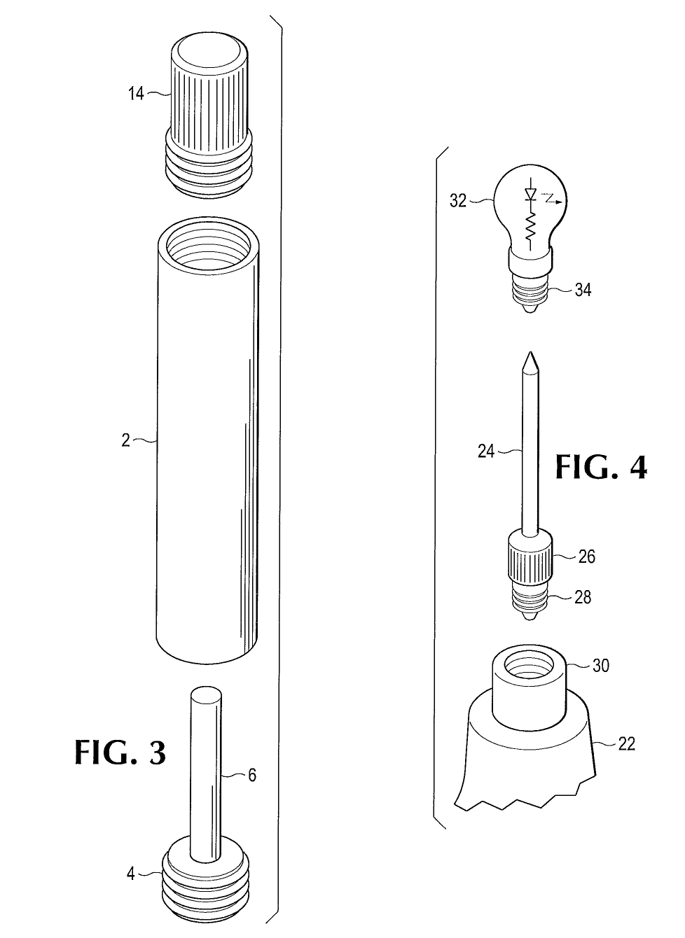

### DETAILED DESCRIPTION

The illustrated appliance comprises a hollow tubular shell 2 made of aluminum. Aluminum was selected for ease of fabrication but it will be appreciated that a material having better thermal insulation properties than aluminum, such as a synthetic polymer material or a ceramic or vitreous material, may be used instead.

The opening at the lower end of the tubular shell 2 is closed by a steel plug 4 that is in threaded engagement with the shell, the threads being rendered water tight by use of conventional PTFE tape (not shown). The plug includes a hollow rod-form projection 6 that extends axially into the shell. The external diameter of the rod-form projection is less than the internal diameter of the shell and accordingly the external surface of the rod-form projection is spaced from the internal surface of the shell around the entire circumference of the projection. A blind cylindrical bore 8 extends axially into and through the plug 4 from its outer surface 10 and extends axially into the rod-form projection, stopping short of the upper end of the projection.

The plug 4 may be fabricated by machining a single piece of metal to form the threaded plug and the rod-form projection, or it may be assembled from multiple components that are fitted together, for example by welding.

The upper end of the shell is internally threaded and is provided with a removable plug 14. The thread of the plug 14 may be provided with PTFE tape for sealing the thread.

The appliance also comprises a battery powered soldering tool 20, such as the model 64GH-150 Cordless Battery-Powered Soldering Iron sold by Radio Shack. This soldering tool has a handle 22 that accommodates four AA cells and a slender soldering tip 24. The soldering tip projects from a larger knurled collar 26 that is provided with a standard Edison screw mount base 28 (FIG. 4) that engages a corresponding socket 30 of the handle for attaching the soldering tip to the handle and providing for supply of electric current from the cells to a resistive heating element included in the soldering tip. The soldering tip is heated by dissipation of electrical energy in the resistive heating element when the soldering tool is energized.

The axial bore 8 in the plug 4 is sized to permit insertion of the soldering tip 24 with a narrow clearance.

In operation of the appliance, a user places a quantity of snow or ice in the container formed by the shell 2 and the plug 4 and screws the plug 14 into the upper end of the shell. The user holds the shell upright to avoid spillage. The user inserts the soldering tip 24 of the soldering tool in the axial bore of the plug 4 so that the knurled collar 26 engages the plug 4. The user energizes the soldering tool so current is supplied to the resistive heating element and the soldering tip heats up. Heat is transferred from the soldering tip to the snow in the shell through the circumferential wall of the projection 6. The heat supplied from the soldering tip melts the snow, allowing the user to ingest the resulting water to alleviate dehydration without employing body heat to supply latent heat of fusion of the snow and thereby increase the danger of hypothermia.

Because the depth of the bore 8 is selected to allow the plug 4 to seat against the knurled collar 26 of the soldering tip, loss of heat through clearance between the plug and the soldering tool is minimized.

The soldering tip 24 is interchangeable with a light bulb 32 (FIG. 4) having a corresponding screw mount base 34 that can screw into the socket 30 of the handle. Provided that the voltage rating of the bulb is appropriate, when the handle is provided with a light bulb in this manner, the electrical energy provided by the cells may be used to energize the bulb to produce a distress signal or for other purposes.

Standard AA cells have a capacity ranging from about 400 mAh to 3400 mAh under 500 mA constant drain at a voltage of 1.5 volts. A single cell having an average capacity of 2000 mAh provides sufficient energy to supply latent heat of fusion of about 16 grams of snow, providing about 16 ml of water. Thus, four cells may provide sufficient energy to melt sufficient snow to provide about 64 ml of water.

The battery powered soldering tool provides a convenient and inexpensive source of energy for melting snow or ice without need for the hiker or other user to carry combustible fuel, which poses its own dangers and difficulties, particularly in a confined space such as a tent or snow cave. The tool may be used not only to thaw ice or snow but under other conditions, for example when the user is not in danger of dehydration, it may be used to energize a signaling lamp or other device. An additional set of batteries is relatively light and convenient for the user to carry.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. An appliance for thawing snow or ice, comprising;
a container defining an interior space,
a rod-form element extending longitudinally into the interior space of the container and spaced from walls of the container about its entire circumference, whereby an external surface of the rod-form element is exposed to material in the interior space, wherein the rod-form element is hollow and defines a passage that is open at an exterior surface of the container, the rod-form element having an end within the interior space of the container and at which the passage is closed, and
a heating tool including a heating element sized to fit closely within the passage defined by the rod-form element, whereby heat dissipated in the heating element is transferred through the rod-form element to the material in the interior space of the container.

2. An appliance according to claim 1, wherein the rod-form element is made of metal.

3. An appliance according to claim 1, wherein the rod-form element is integrally formed with a plug fitted in an opening in a wall of the container.

4. An appliance according to claim 1, wherein the heating tool is a battery powered soldering tool and the heating element comprises a soldering tip of the soldering tool.

5. An appliance according to claim 4, wherein the heating tool includes a handle to which the soldering tip is removeably attached by a threaded base of the soldering tip engaging a corresponding socket of the handle.
